(19) United States
(12) Patent Application Publication
(10) Pub. No.: US 2022/0405068 A1
(43) Pub. Date: Dec. 22, 2022

(54) MANAGING ASSET PACKAGES FOR INTERACTIVE BOT DEVELOPMENT

(71) Applicant: Microsoft Technology Licensing, LLC, Redmond, WA (US)

(72) Inventors: Benjamin Abraham BROWN, Austin, TX (US); Steven Wayne ICKMAN, Camano Island, WA (US); Christopher Lee MULLINS, Sammamish, WA (US); Christopher Michael WHITTEN, Seattle, WA (US); Lili CHENG, Bellevue, WA (US); Scott Jeff GELLOCK, Seattle, WA (US)

(21) Appl. No.: 17/349,632

(22) Filed: Jun. 16, 2021

(51) Int. Cl. G06F 8/36; G06F 8/34

(52) U.S. Cl. CPC G06F 8/36; G06F 8/34

(57) ABSTRACT

The present disclosure relates to systems, methods and computer readable media for providing tools and features related to developing asset packages that may be incorporated within the framework of various bot packages. For example, systems disclosed herein can provide an asset development interface that enables a user of a computing device to develop various types of bot packages by adding and/or modifying asset packages. The systems provide a mechanism whereby a developer can obtain an asset package including one or more discrete action components that are pre-configured and pre-packaged in a way that enables the asset package to be incorporated into the framework of the bot or, alternatively, within the framework of another asset package. The systems described herein further enable content of the asset packages to be selectively accessible to users and associated computing devices that are authorized to view and use the asset packages.

### BACKGROUND

Computer-based systems have increasingly changed the manner in which users interact with computers and various applications. For example, many actions and tasks traditionally performed using conventional user interface elements (e.g., menus, forms, etc.) are being replaced with conversational interfaces that enable a user to provide a variety of inputs in a more conversational manner akin to speaking with a human assistant. Indeed, bots are becoming increasingly common mechanisms for interfacing with applications, operating systems, and other computing systems.

While modern bots (e.g., conversational bots, text-driven bots, artificial intelligence bots) have provided significant advances to facilitate interaction with a wide spectrum of end-users, development of modern bots presents a number of difficulties to developers and end-users alike. For example, conventional systems for developing bots often require significant programming experience and domain knowledge of the computing environment within which a bot will be incorporated. In addition, third-party repositories of bot applications are generally difficult to incorporate into a variety of applications. Bot programs are also often difficult to modify, and generally provide an inflexible solution to developers looking to solve a particular problem or perform a specific function.

In addition to development difficulties, many conventional bot development and distribution systems are unable to effectively protect content included within various bot applications. For example, bot applications may include information about a particular individual or organization that that a developer may wish to remain secure. Other developers may wish to license or selectively provide access to a bot application on a limited basis or for a limited time. While conventional bot distribution systems can provide convenience in distributing and reusing bot components, these systems are often unable to protect digital rights of the creators or owners of those bot applications.

These and other problems exist in connection with packaging, distributing, and reusing text-driven bots.

### BRIEF DESCRIPTION OF THE DRAWINGS

FIG. 1 illustrates an example environment of an asset development system in accordance with one or more embodiments.

FIG. 2 illustrates an example presentation of an asset package showing a dialog interface for developing an asset package in accordance with one or more embodiments.

FIG. 3 illustrates an example presentation of an asset package showing an example authoring view and an example property view for a component of the asset package in accordance with one or more embodiments.

FIGS. 4A-4C illustrate an example implementation showing an addition of one or more pre-packaged asset packages to a framework of a bot package in accordance with one or more embodiments.

FIGS. 5A-5B illustrates an example implementation showing modification of an action package within one or more views of the asset package in accordance with one or more embodiments.

FIG. 6 illustrates an example series of acts for modifying an asset package in accordance with one or more embodiments.

FIG. 7 illustrates an example series of acts for incorporating an asset package within a framework of a bot package in accordance with one or more embodiments.

FIG. 8 illustrates certain components that may be included within a computer system.

### DETAILED DESCRIPTION

The present disclosure is generally related to a bot development system that facilitates flexible management and development of bot applications (e.g., bot packages) using pre-configured asset packages and based on features and functionalities provided by a bot development interface. For example, a bot development system can provide an asset development interface that enables a user of a computing device to develop various types of bot packages by adding and/or modifying asset packages in accordance with one or more embodiments described herein. The bot development system may provide interactive features that enable a user to add and remove asset packages (e.g., pre-packaged asset packages) to and from bot packages without interrupting or otherwise disrupting other functionalities of the bot packages. The bot development system further facilitates presentation of interactive views that enable a user to modify properties and other features of respective actions and assets using an intuitive and user-friendly dialog interface. Moreover, the bot development system provides features and functionality related to protecting data of the bot packages as well as preserving digital rights associated with distribution and reuse of the bot packages themselves.

As an illustrative example, in one or more embodiments, a bot development system can provide a presentation of an asset package including a dialog of one or more bot actions that are consumable within a bot package. The bot development system can detect a selection of an edit element presented via a graphical user interface within the presentation of the asset package. The bot development system can further present an action package showing an authoring view and a property view showing features and other characteristics of one or more bot actions within a framework of the asset package. As will be discussed in further detail below, the bot development system may provide various features and tools for modifying these features and characteristics within the authoring view and/or property view. In one or more embodiments, the bot development system can facilitate incorporation of the action package within the framework of the asset package, which may be consumed within a framework of the bot package.

The present disclosure includes a number of practical applications that provide benefits and/or solve problems associated with managing asset packages as part of a process related to creating, modifying, or otherwise developing functions of a bot package. Some illustrative examples of various applications and benefits will be described herein. It will be understood that these benefits and associated features are described by way of example and various features and functionalities described herein may include additional benefits and applications.

As an example, in one or more embodiments, the bot development system provides an intuitive and convenient dialog interface (e.g., an asset package canvas) that provides interactive features that enables a developer to create and modify asset packages. For instance, in one or more embodiments described herein, the bot development system provides an authoring view and associated property view showing characteristics of an asset package and corresponding properties. In one or more embodiments, interacting with and modifying various properties can cause the bot development system to modify corresponding features and characteristics of the asset package within the authoring view. Alternatively, modifying one or more characteristics or code displayed within the authoring view may be transcribed to show corresponding modifications to various properties of the asset package within the property view.

In addition to providing a convenient editing interface to modify specific action characteristics, the bot development system can additionally provide access to a wide variety of asset packages to incorporate within a framework of a bot package. By way of example, the bot development system can provide access to a collection of primitive assets (e.g., pre-packaged assets already incorporated within a bot development system) and third-party developed asset packages. In addition, the bot development system can provide access to modifiable asset packages as well as adaptive cards that may be incorporated within a framework of a bot package.

As noted above, the bot development system can facilitate incorporation of the asset package(s) into a new or existing framework of a bot package. For example, as will be discussed in further detail below, the bot packages may present an interface that enables the bot packages to receive and consume asset packages of a compatible class and having a compatible mounting interface. Further, the bot development system presents a dialog interface that enables a developer to add and/or modify asset packages that follow a compatible configuration that both enables pre-packaged assets to be added to an asset package while also enabling the new and/or modified asset package(s) to be consumed by the bot system.

In addition to the above, the bot development system can implement one or more security measures related to providing selective access and protecting digital rights associated with content of the bot packages. For example, in one or more embodiments, a bot package may include encrypted content that is selectively accessible to individuals and associated computing devices that have authorization to access the encrypted content. This provides features and functionality that enables individuals and organizations to protect assets (e.g., data) included within the respective bot packages. In addition, this enables individuals and organizations to selectively license bot packages to individuals for variable periods of time.

As illustrated in the foregoing discussion, the present disclosure utilizes a variety of terms to describe features and advantages of the systems described herein. Additional detail is now provided regarding the meaning of some example terms.

For example, as used herein, a “bot,” “bot application,” or “bot package” may refer interchangeably to a program or application that is configured to perform one or more tasks. In one or more embodiments described herein, a bot package refers to software or a mix of hardware and software. In one or more implementations described herein, a bot package refers specifically to a conversational bot, including a text-driven chat bot or a voice-driven chat bot. In one or more embodiments, the conversational bot refers to an artificial intelligence (AI) bot that has been trained to process natural language and simulate human interactions using natural language processing (NLP). As will be discussed in further detail below, a bot package may include any number of asset packages having one or more associated actions and/or tasks that the bot is trained to implement.

As used herein, a “bot development system” may refer to a software service, such as a software development kit (SDK) that provides a variety of tools that enable developers to create, modify, or otherwise develop bots and associated asset packages that are capable of communicating across various channels (e.g., websites, applications) and devices (e.g., personal computers, mobile devices, home-based voice assistants). As noted above, the bot development system may be configured to develop bots capable of conducting auditory communications, text communications, or a variety of both. Additional information in connection with features and functionality of the bot development system in connection with developing and incorporating asset packages within bot packages is provided below in connection with example implementations.

As noted above, a bot package may include any number of asset packages. As used herein, an “asset package” (or more simply, “asset”) may refer to a set of one or more actions including instructions that are executable by the bot package to perform various tasks defined by the asset package(s). For example, an asset package may refer to a subset of features and functionality of the bot package contained within a specific package. An asset package may include a bundle of language understanding (LU) and/or language generation (LG) files. One or more action components included within an asset package may refer to one or more LU or LG files that provide a discrete feature of functionality of the asset package. As will be discussed in further detail below, an asset package may refer to a variety of package types including, by way of example, primitive assets (e.g., pre-packaged assets incorporated within a software package of the bot development system), third-party assets, and various custom asset packages. The asset packages may also refer to modified asset packages as well as adaptive cards. An adaptive card may refer to an object or mechanism to describe user interface elements in a way that the elements can be rendered within a variety of application interfaces. For instance, an adaptive card may refer to a single block or user interface that could appear within an application interface and may include one or more input elements associated with corresponding instructions for executing any number of actions.

As will be discussed in further detail below, an asset package may include any number of actions or action packages defined therein. As used herein, an action package may refer to a discrete component of an asset package including instructions executable by a bot to perform a corresponding task or action. Indeed, action packages may include discrete components of the asset package including, by way of example and not limitation, triggers, prompts, and any other executable action performable by a bot package. In one or more embodiments, the action packages refer to adaptive cards (or may include one or more adaptive cards), which may refer to programmable and customizable graphical elements having one or more interactive inputs that are displayable within a graphical user interface of an application.

As used herein, an asset package may be presented via a dialog interface showing one or more views of the asset package (or discrete actions of the asset package). As will be discussed in further detail herein, the views of the asset package may include a display of various properties and characteristics of the asset package (and discrete components thereof). By way of example, a dialog interface may show an authoring view that presents a hierarchy or flow of components (actions) that make up one or more asset packages. As another example, a dialog interface may include a property view showing properties and other characteristics of the asset package and/or specific actions that make up the asset package. Further information in connection with these views will be discussed in further detail below in connection with the figures showing example implementations.

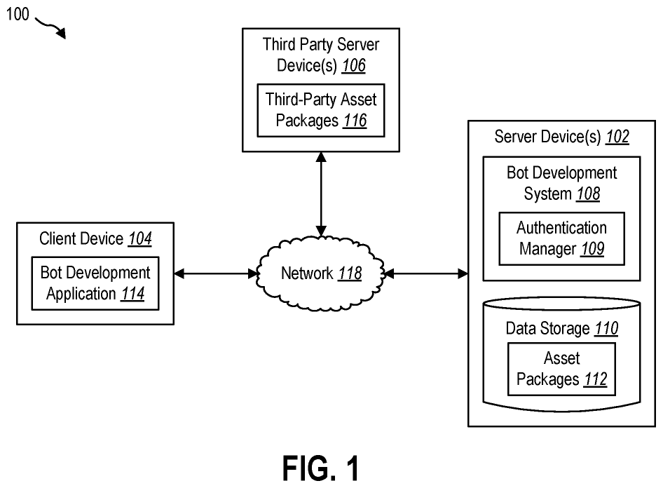

Additional detail will now be provided regarding systems, methods, and computer-readable media described in relation to illustrative figures portraying example implementations of the bot development system. For example, FIG. 1 illustrates an example environment 100 showing an example implementation including systems and applications for enabling an end-user to manage creation, modification, and other developments of bot packages. As shown in FIG. 1, the environment 100 includes one or more server device(s) 102, a client device 104, and one or more third-party server device(s) 106.

The server device(s) 102 may include a bot development system 108. The bot development system 108 may include an authentication manager 109 thereon. The server device(s) 102 may additionally include a data storage 110 having asset packages 112 (e.g., primitives and other pre-packaged asset packages) accessible to the bot development system 108. Also shown in FIG. 1, the client device 104 may include a bot development application 114 associated with the bot development system 108. Moreover, as shown in FIG. 1, the third party server device(s) 106 may include third party asset packages 116 accessible to the bot development system 108 and/or bot development application 114.

While FIG. 1 illustrates an example implementation showing a bot development system 108 and bot development application 114 implemented on respective devices, it will be understood that features and functionalities of these respective components may be implemented differently between respective embodiments. For example, while one or more embodiments described herein refer to features and functionalities of a bot development system 108 implemented wholly on a server device, one or more of the features and functionalities of the bot development system 108 may be implemented within the bot development application 114 on the client device 104. Similarly, one or more features and functionalities described herein in connection with the bot development application 114 may be implemented wholly or partially on the bot development system 108 on the server device(s) 102.

As an illustrative example, in one or more embodiments, the bot development application 114 refers to a software application configured to generate and display various views of one or more assets via a graphical user interface showing features and functionalities described herein. Alternatively, in one or more embodiments, the bot development app 114 may refer to a web browser that accesses an interface provided by the bot development system 108 including tools and features related to developing bot packages and/or asset packages. Accordingly, while one or more embodiments refer to implementations that involve a bot development system 108 that provides a presentation of asset packages showing authoring view and/or property views of various asset packages, features and functionality of the bot development system 108 described herein in connection with the example environment 100 shown in FIG. 1 may similarly apply to alternative implementations.

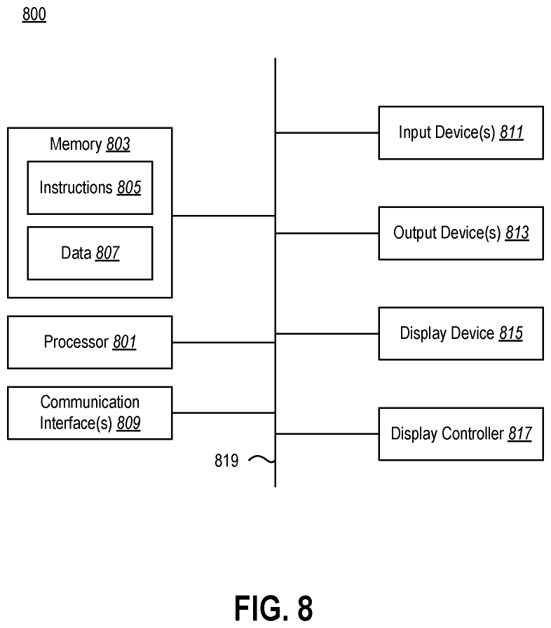

The respective devices 102-106 may refer to a variety of computing devices. For example, the client device 104 may refer to mobile devices such as a mobile telephone, a smartphone, a personal digital assistance (PDA), a tablet, or a laptop. Additionally, or alternatively, the client device 104 may refer to a non-mobile device such as a desktop, computer, server device, or other non-portable computing device. The server device(s) 102 and third-party server device(s) 106 may similarly refer to various types of computing devices, such as network devices on a cloud computing system or other distributed network of devices. Each of the devices illustrated in FIG. 1 may include features and functionality described below in connection with FIG. 8.

As will be discussed in further detail below, the bot development system 108 can provide a dialog interface showing a presentation of one or more asset packages via a graphical user interface of the client device 104. For example, in one or more embodiments, the bot development system 108 and/or bot development application 114 provides an interactive interface (e.g., a dialog interface) showing a framework for a conversational bot including asset packages having discrete actions that make up the respective asset packages. In one or more embodiments, the bot development system 108 causes the client device 104 to provide a display of an asset package including various interactive elements that enable a user of the client device 104 to create new asset packages, modify existing asset packages, and otherwise develop asset packages for incorporation within an associated bot package.

As mentioned above, the bot development system 108 may include an authentication manager 109 implemented thereon. The authentication manager 109 may provide features related to securing data for a corresponding asset package(s). For example, in accordance with one or more embodiments described herein, an asset package may include a manifest portion and a content portion. The manifest portion may include publicly accessible information, such as a name of a file, an identifier of a developer, contact information, licensing information, and an identifier of an authentication server. The manifest may be used to access various information about an asset package without granting full access to content of the asset package. In one or more embodiments, the manifest refers to an extensible markup language (XML) file stored in conjunction with additional encrypted content of an associated asset package. Moreover, in one or more embodiments, the manifest is digitally signed to prevent modification or tampering of the manifest and/or content of the asset package(s).

In addition to the manifest, the asset package(s) may include encrypted content including additional features and characteristics of the asset package(s). For example, the encrypted content may include commands, action components, and any functional components of the asset package(s). The encrypted content may be encrypted using any of a variety of conventional encryption techniques, such as standard industry digital rights management (DRM) packaging. In addition, a developer of the asset package(s) may utilize any of a number of authentication services to encrypt the asset content as well as provide selective access to the content of the asset package(s).

The authentication manager 109 may protect or otherwise limit access to encrypted content of one or more asset packages in a variety of ways. For example, in one or more embodiments, the authentication manager 109 enables a developer or a creator of an asset package to restrict access to a select one or more users. For instance, where an organization uses a bot package unique or otherwise specific to the organization (e.g., a timecard reporting bot), the organization may have a vested interest in maintaining functionality of the content of the various packages included within the bot.

In this and other examples, the asset package may include encrypted content, but be made available via a public, open-source, or otherwise less restricted platform for developing and/or distributing bot packages generally. By encrypting the content of the asset package, the organization may provide access to the package file to anyone including the ability to read the unencrypted manifest, but limit access to the encrypted content so that only those users and/or associated computing devices can view specific content (e.g., property view, authoring view), incorporate the asset package within the framework of a bot package, and/or execute the asset package or associated bot package on an authorized computing device.

In addition to limiting access to the specific content that makes up the asset package, the authentication manager 109 may additionally limit access to content including data or digital assets linked or otherwise called upon at runtime by an asset package. For example, where an asset package calls on a particular library, file, or other data asset that is restricted to individuals associated with a particular organization, encryption of the asset package may provide a level of protection against unauthorized access of the sensitive data asset(s). In one or more embodiments, the authentication manager 109 performs one more additional authentication checks to ensure that a user of the asset package has access to the sensitive data asset(s) linked or otherwise indicated by the bot package. For example, the authentication manager 109 may authenticate that a user not only has access to content of the asset package, but also authenticate that the user has permission to access the data asset(s) linked or called on by the asset package.

Under a similar framework, the authentication manager 109 may limit access to content of an asset package and/or bot package to those who have a valid license for the asset package/bot package. For example, as mentioned above, the manifest may include licensing information and/or authentication information that would enable a creator or owner of an asset package to restrict access to users who have a valid license and access to security keys that enable individuals and other entities to access the asset package for some period of time (as defined by the license). Thus, a user may download an asset file and view information from the manifest, but be restricted from accessing the encrypted content of the asset file until obtaining a valid license.

The authentication manager 109 may perform one or more authentication checks at a number of different points in the workflow of developing, accessing, and executing bot packages and associated asset packages. For example, the authentication manager 109 may perform an authentication check when the asset package is added to a package management platform and made accessible to download by users of the platform. As another example, the authentication manager 109 may perform an authentication check prior to providing access to any of the content of the asset package or bot package (or data assets called on by the asset or bot package(s)). For instance, the authentication manager 109 may perform an authentication check prior to providing an authoring and/or property view as will be discussed in further detail below. As another example, the authentication manager 109 may perform an authentication check every time a bot package is launched. Each of these checks prevents non-authorized distribution of packages, non-authorized viewing of encrypted content, and non-authorized execution of packages within a bot application.

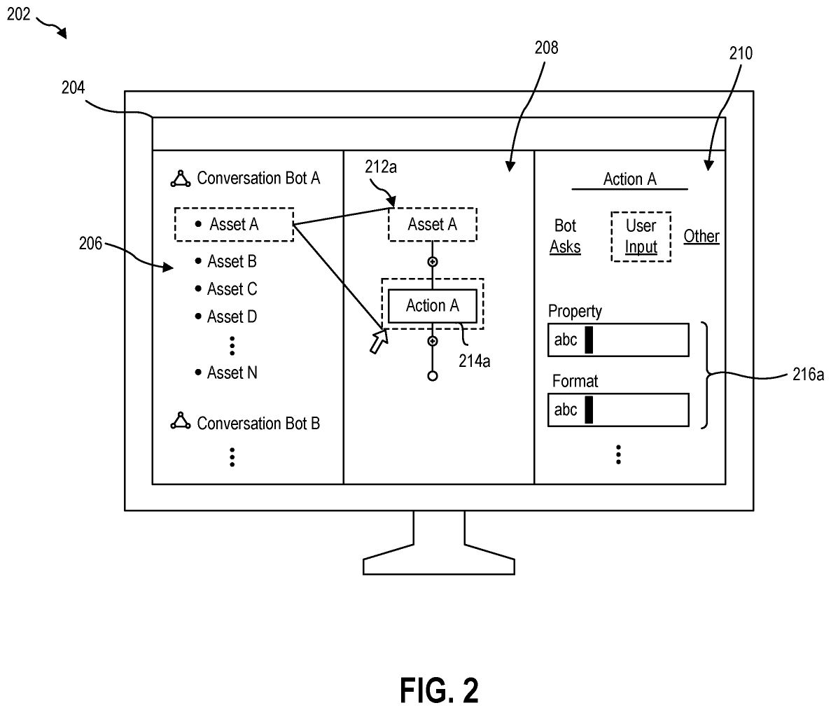

Additional detail will now be discussed in connection with example dialog composer interfaces that the bot development system 108 and/or bot development application 114 can present via a graphical user interface of a computing device (e.g., client device 104). For example, FIG. 2 illustrates an example computing device 202 showing a graphical user interface 204 (e.g., a dialog interface) in accordance with one or more embodiments described herein. The computing device 202 may be an example of the client device 104 described above in connection with FIG. 1 and having a bot development application 114 thereon. In one or more embodiments, the dialog interface is generated by the bot development application 114. In one or more embodiments, the dialog interface is generated by the bot development system 108 and provided via a web browser or other example implementation of the bot development application 114. As shown in FIG. 2, the dialog interface may include multiple sections or views, including a bot menu 206, an authoring view 208, and a property view 210.

As shown in FIG. 2, the bot menu 206 may include selectable icons representative of one or more bot packages having any number of asset packages. For example, the bot menu 206 shows a first conversational bot package (Conversational Bot A) and a second conversational bot package (Conversational Bot B). The bot menu 206 may include any number of bot packages. The bot menu 206 may further include a listing of any number of asset packages (e.g., Assets A-N) that have been incorporated within a framework of the corresponding conversational bot package. While not shown in FIG. 2, the various bot packages may include many of the same asset packages in common. Moreover, one or more of the asset packages may be modified for one of the respective bot packages in accordance with one or more examples described below.

As shown in FIG. 2, the authoring view 208 shows an asset dialog showing one or more action packages that make up the framework of the corresponding asset package. For example, a first asset dialog 212a (Asset A) includes a first action component 214a (Action A). While FIG. 2 shows an example showing a first asset dialog 212a having a single action component 214a incorporated therein, other implementations may include any number of actions that make up the framework of a corresponding action package. Indeed, in one or more embodiments, a single action component may include one or more actions incorporated therein with each action component including one or more corresponding actions.

As further shown in FIG. 2, a property view 210 can show one or more properties and other characteristics of a selected asset package and/or action component. In this example, a first action package 214a may be selected to cause the corresponding property view 210 to display a listing of properties for the action component 214a. In particular, the property view 210 shows a listing of action properties 216a showing a property and a format for the selected action component 214a. The listing of action properties 216a may include any number of properties that may be specified, modified, or otherwise developed for a corresponding action. In one or more embodiments, the property view 210 may show different listings of different types of properties or characteristics (e.g., bot asks properties, user input properties, other properties) which may depend on various behavior characteristics of the selected action component.

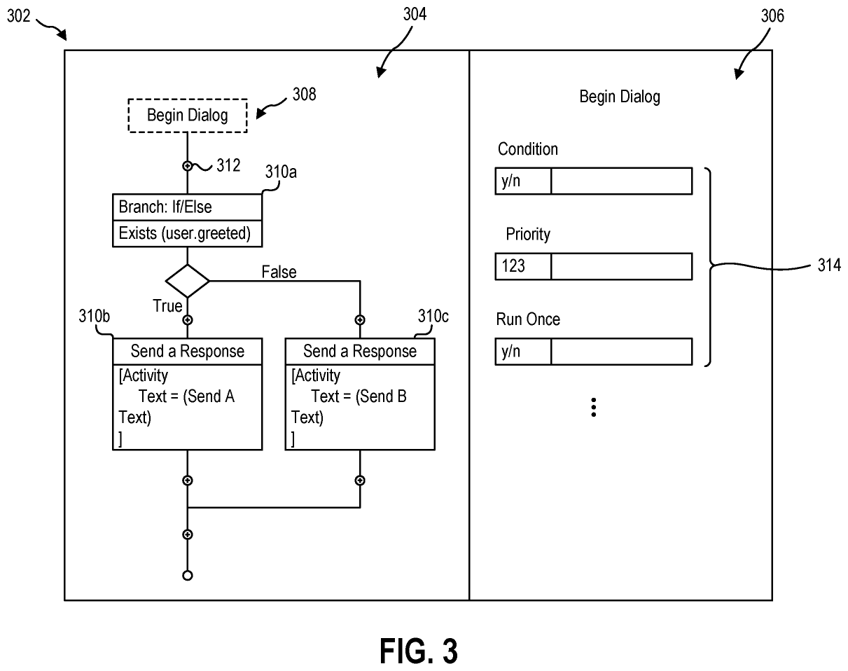

FIG. 3 illustrates a more detailed example implementation of an asset package presentation in accordance with one or more embodiments. In particular, FIG. 3 illustrates a graphical user interface 302 (e.g., a dialog interface) showing an authoring view 304 and a property view 306. As shown in FIG. 3, the bot development system 108 can provide a dialog showing a framework for an asset package 308 associated with beginning a dialog between a user and a bot application. In one or more embodiments, this asset package 308 is previously incorporated within a framework of a bot package. Alternatively, in one or more embodiments, the asset package 308 represents an asset package prior to being incorporated within a framework of the bot package.

As shown in FIG. 3, the asset package 308 includes a set of action components 310a-c represented by action boxes within a framework of the dialog. In one or more embodiments, the action components 310a-c may represent discrete actions that may be performed by a bot application. Alternatively, in one or more embodiments, the action components 310a-c may reference other asset packages and may be expanded to include multiple discrete actions therein.

In this example authoring view 304, the asset package 308 may include a first action component 310a including an if/else action. In this example, the first action component 310a may include an action for determining whether a user exists (e.g., whether a user is present and capable of interfacing with the bot application) and whether the user will receive any responses or text provided via a chat interface. In one or more embodiments, the action component 310a (e.g., the action box or other icon representative of the action component) may include more comprehensive instructions that are executable by a bot application. For example, in one or more embodiments, the action component 310a may include code in a particular language (e.g., Javascript, C#) and/or having a specific schema or format showing specific instructions that are executable by the bot package to perform a respective action. In this example, the action component 310a may include a link (e.g., user.greeted) that references other instructions having a format or schema that is compatible within the framework of the asset package 308. These instructions may be accessible via a local storage of the client device 202, a remote data storage (e.g., data storage 110) associated with the bot development system 108, and/or a record of third party asset packages maintained on a third party server device (e.g., third party server device(s) 106). In one or more embodiments, the link is a uniform resource locator (URL) that references a remote site or file having instructions that may be incorporated within the framework of the corresponding action component.

As shown in FIG. 3, the dialog may include a decision box that branches between a second action component 310b and a third action component 310c. Each of the second action component 310b and the third action component 310c may have associated sets of instructions depending on the determination made by the bot application in accordance with the first action component 310a. For example, where a condition associated with the first action component 310a is true, a bot interface may generate a response based on text included within the second action component 310b (denoted as “SendAText”). Alternatively, where a condition associated with the first action component 310b is false, the bot interface may generate a response based on text included within the third action component 310c (denoted as “SendBText”).

As further shown in FIG. 3, the dialog may include any number of edit elements or edit icons. For instance, the illustrated example shows a number of add icons 312 at various locations within the authoring view 304 corresponding to locations within the dialog that one or more additional action packages or asset packages may be added to the framework of the asset package 308. It will be understood that the add icons 312 refer to an example of an edit element that may be used specifically to add one or more actions and/or assets within the framework of an asset package. Other types of edit elements may further be displayed.

Indeed, as used herein, an “edit element” or “edit icon” may interchangeably refer to any graphical element or icon corresponding to a location within a dialog for an asset package that is compatible with a set of corresponding modifications. For example, an edit icon may include an add icon 312 as discussed above that corresponds to a location within the dialog where an asset package or discrete action package may be added within the framework of the dialog. Another example edit element may refer to an action box corresponding to an action package. For example, as mentioned above in connection with FIG. 2, and as will be discussed in further detail below, selecting an action box may cause a property view for the selected action component to be displayed that enables a user to modify one or more properties and other characteristics of an asset package and/or action component. Indeed, any graphical icon that is displayable within an authoring view and that may be selected as part of a process of modifying or otherwise developing an asset package may refer to an edit element or edit icon.

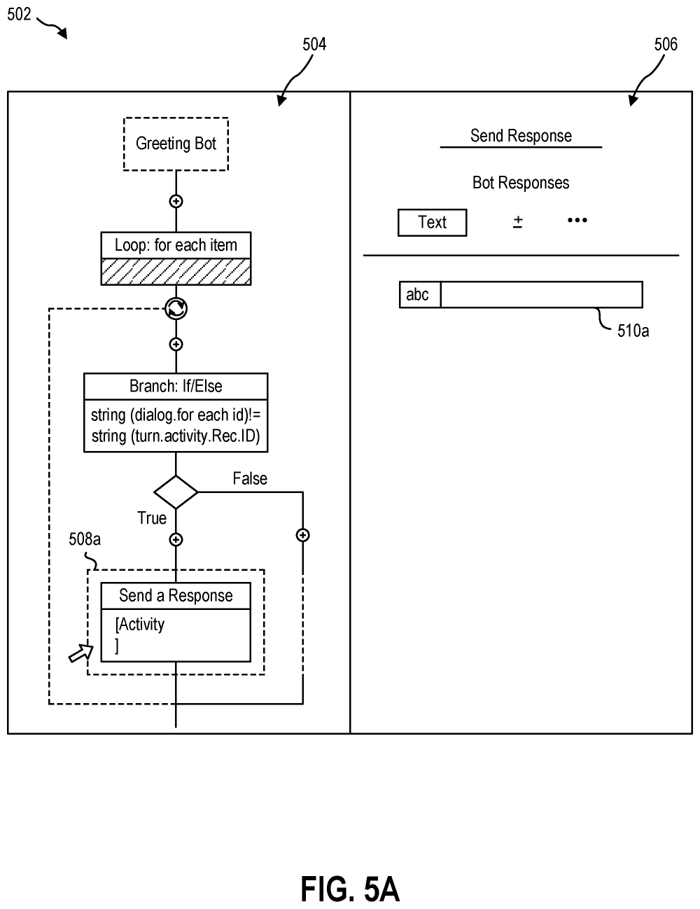

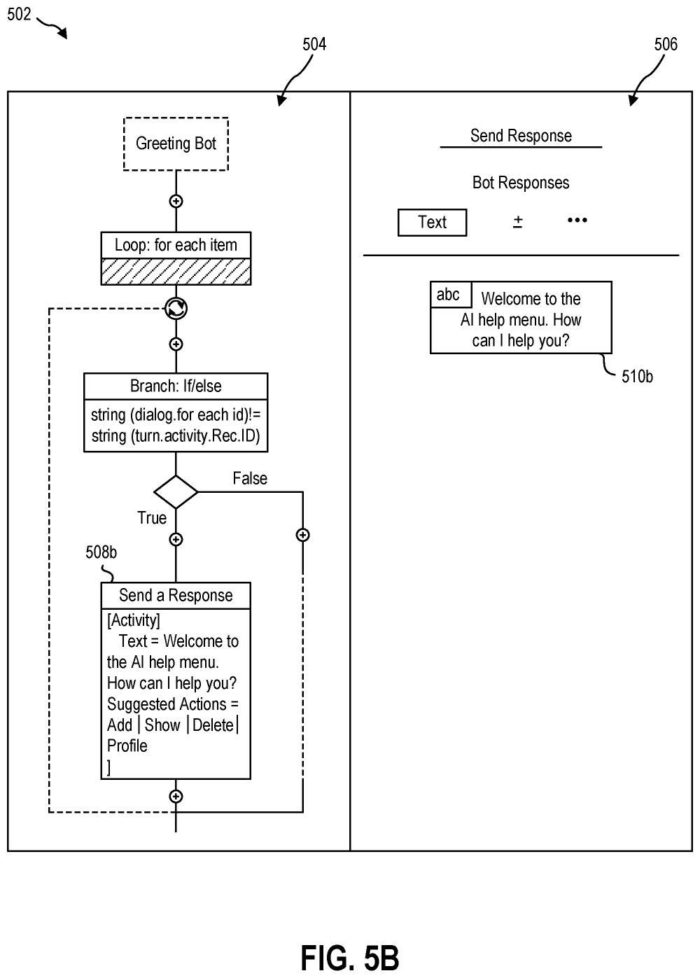

As mentioned above, FIG. 3 also illustrates an example property view 306 showing one or more properties of the corresponding asset package 308. In accordance with other examples herein, the property view 306 includes interactive property elements 314 showing various properties that may be modified by a user. In this example, one or more conditions, properties, and number of times that the asset package should run refer to various interactive properties that a user may edit from within the property view 306. As will be discussed in further detail (e.g., in connection with FIGS. 5A-5B), one or more modifications to the property view may be automatically translated or otherwise applied to corresponding components within the authoring view 306.

It will be noted that FIG. 3 illustrates an example implementation showing features related to creating a new asset packet and/or modifying an existing asset package. As discussed above, this may include adding action boxes having associated instructions for executing one or more bot functions based on various trigger conditions. As will be discussed below, these action boxes may represent pre-packaged assets that may be added from a local or remote database of asset packages. In addition, and as will be discussed in further detail below, this asset package (e.g., the new and/or modified package) may be distributed, packaged, or otherwise made accessible to other devices that make use of the bot development system 108 and/or bot development application 114. Accordingly, features and functionality described in connection with FIG. 3 (and other figures herein) may refer to user-facing interactive features that enable discrete components that may become discrete components of bots (e.g., conversational bots) and may be packaged, distributed, installed, and reused in accordance with one or more embodiments described herein.

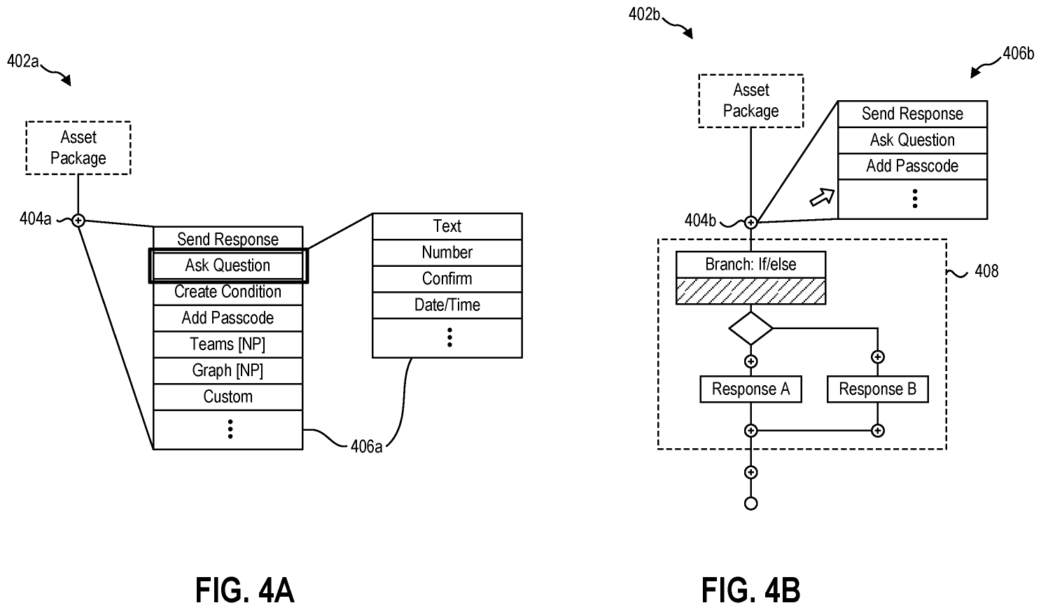

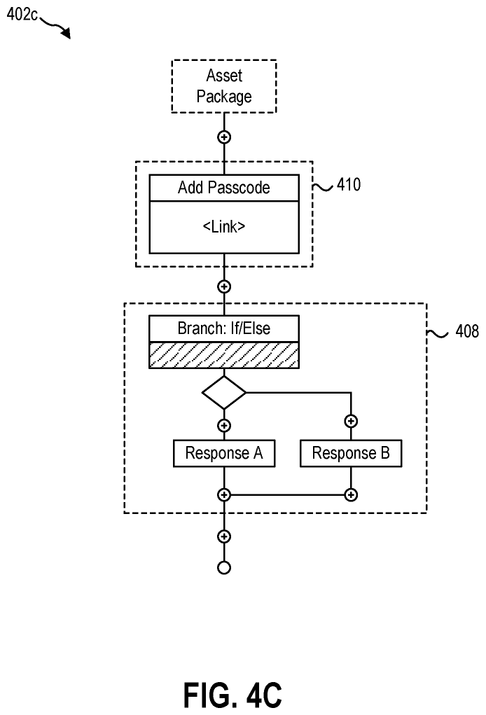

FIGS. 4A-4C illustrate an example workflow showing an implementation in which the bot development system 108 can facilitate addition and development of an asset package that can be consumed within a bot package. For example, FIG. 4A shows a first iteration of an asset package 402a. The asset package 402a includes an empty dialog including an add element 404a associated with a location within the asset package 402a that one or more actions and/or action packages may be added within the framework of the asset package 402a (e.g., the empty asset or empty dialog).

As shown in FIG. 4A, in response to detecting a selection of the add icon 404a, the bot development system 108 can provide a listing of asset packages 406a including indicators of asset packages that can be incorporated within a framework of a bot package. For example, as shown in FIG. 4A, in response to detecting a selection of the add icon 404a, the bot development system 108 can provide a first listing of asset packages having various functions such as “Send Response,” “Ask Question,” “Create Condition,” and “Add Passcode.” Other items listed may include application-specific asset packages, such as “Teams” and “Graph” referring to assets that may be incorporated within Microsoft Teams or assets that may be incorporated within the Microsoft Graph.

As shown in FIG. 4A, one or more of the asset packages provided within the listing of asset packages 406 may include a security indicator. For example, as shown in FIG. 4A, the “Teams” and “Graph” indicators may include an “NP” indicator to indicate that asset packages that fall within these respective categories may require authentication prior to viewing content therein and/or executing the asset packages within a bot. Thus, while the bot development system 108 may download asset packages from these respective categories, the bot development system 108 may be limited from viewing encrypted content therein and/or executing the asset packages within a bot framework without obtaining valid authorization.

As further shown, in one or more embodiments, the bot development system 108 provides a “Custom” icon referring to custom asset packages that may have been created, modified, or otherwise developed by a user of the bot development system 108. For example, while not specifically shown in the figures, where a user were to create and save a new asset package or modify an existing asset package, the resulting asset package may be added to a list of available custom packages that may be added to the framework of an asset package and/or bot package. Accordingly, the bot development system 108 can provide a listing of consumable assets from a variety of asset-types including primitives, third-party assets, customizable assets, and application-specific asset packages. As an illustrative example, where a user creates or modifies an asset package similar in accordance with the implementation(s) discussed above in connection with FIG. 3, the resulting new asset package or a new modified version of the asset package may be added to a database referenced by the listing of asset packages 406a shown in FIG. 4A. Indeed, in accordance with one or more embodiments described herein, a user may create any number of custom asset packages to be added to an accessible collection of asset packages, which may be accessed via an interface similar to the implementations shown in FIGS. 4A-4C. These asset packages may be made locally available to a client device on which the asset packages were created or modified. In addition, or as an alternative, these asset packages could be added to a database of pre-configured asset packages that are available to other users of the bot development system 108.

As shown in FIG. 4A, one or more of the asset icons may refer to a category of asset packages and be associated with a secondary list of actions or other asset packages. For example, as shown in FIG. 4A, in response to selecting the “Ask Question” icon, the bot development system 108 may present a secondary list of icons indicating asset packages associated with different types of questions that may be asked. For example, the listing of asset packages 406a may include a secondary list showing “text,” “number,” “confirm,” “date/time,” and any other type of question that a bot or user may ask within a framework of an asset package.

It will be noted that the bot development system 108 can obtain the listing of asset packages 406a from any number of sources or repositories. For example, some or all of the icons from the list of asset packages 406a may include primitives that are pre-configured and native to the bot development system 108 and/or bot development application 114. In this example, selected asset package can be obtained from a local storage of a client device and/or a data storage (e.g., data storage 110) on a server device. In addition, or as an alternative, one or more of the asset packages may refer to third-party asset packages (e.g., third-party asset packages 116) accessible via a third party server device.

In one or more embodiments, the bot development system 108 provides a unique listing of asset packages based on one or more characteristics of the relevant bot package and/or asset package. For example, where the bot package refers to a specific type of bot that utilizes a particular scheme or format, the displayed listing of assets may be different than those presented for another bot package (or other asset package) having a different schema and/or format. Moreover, the listing of asset packages may differ depending on the application within which the asset package is to be incorporated. For example, where a first bot package is being run in conjunction with Teams, the bot development system 108 may provide a listing of asset packages that are pre-configured as compatible with Teams. Alternative, where a second bot package is being run in conjunction with Excel, the bot development system 108 may provide a different listing of asset packages that are pre-configured as compatible with Excel. Moreover, where an asset package is applicable universally to multiple different applications (e.g., such as may be the case with an adaptive card), the asset package may be included within multiple lists presented in connection with different bot packages configured to run in conjunction with different applications.

As shown in FIG. 4B, upon selecting the action icons corresponding to a text question (e.g., as shown in FIG. 4A), the bot development system 108 can cause the corresponding asset package to be added to the dialog. For example, FIG. 4B illustrates a second iteration of the asset package 402b in which a selected asset package including a pre-configured set of actions (e.g., a primitive action package) 408 has been added to the framework of the dialog. It will be noted that the set of actions 408 can refer to a similar asset package as discussed above in connection with FIG. 3. Nevertheless, other asset packages may just as easily be added to the framework of the asset package 402b based on selection of any of icons listed as shown in FIG. 4A.

As shown in FIG. 4B, a number of edit icons appear within the revised framework of the asset package 402b. For example, one or more add icons may appear on both sides of the added set of actions 408. It will be noted that the add icons may be added by the bot development system 108 to the dialog based on any location within the dialog that one or more pre-configured asset packages can be added or otherwise incorporated into the functionality of the asset package and corresponding bot package.

As shown in FIG. 4B, the bot development system 108 can provide a second listing of asset packages 406b based on selection of a second add icon 404b. In one or more embodiments, the listing of asset packages 406b may be similar or identical as the first listing of asset packages 406a from FIG. 4A. Alternatively, in one or more embodiments, the listing of asset packages 406b may differ based on different compatibilities or differences between interfaces in the asset packages between the first add icon 404a and the second add icon 404b.

In this example, a user may desire to select an “Add Passcode” feature to supplement previously incorporated features of the asset package 402b. Thus, based on detecting a selection of an “Add Passcode” element, the bot development system 108 can provide an updated third iteration of the asset package 402c showing an additional set of actions 410 for another asset package. As shown in FIG. 4C, this additional asset can be added to the framework of the asset package 402c such that the resulting asset package 402c includes both the first set of actions 408 of the first selected asset package and the second set of actions 410 of the second selected asset package.

As noted above, selecting any of the pre-configured asset icons can cause a corresponding set of action(s) or asset package(s) to be incorporated within a framework of the asset package (e.g., asset package 402c). For example, in one or more embodiments, the bot development system 108 provides a listing of asset packages having a particular asset class that is compatible with the corresponding bot package. Thus, in one or more embodiments, the bot development system 108 provides a listing of eligible asset packages based on those asset packages including configuration information that facilitates mounting the asset package within a framework of the bot package and which includes additional instructions to autoload any actions included as part of the asset package. In one or more embodiments, the asset package and bot package are configured with compatible interfaces, which may correspond to locations of add or other edit icons displayed within the dialog interface. These compatible interfaces allow arbitrary components (e.g., asset packages) to facilitate mounting to the bot packages. Similarly, these interfaces allow the bot packages to mount the asset package without having a prior knowledge of the asset package itself.

As noted above, the bot development system 108 can facilitate modifying one or more asset packages that have been previously added or otherwise integrated within a framework of a bot package. For example, in one or more embodiments, the bot development system 108 facilitates interaction with one or more views (e.g., dialog menu view, authoring view, property view) to modify various characteristics of the bot components.

To illustrate, FIG. 5A shows an example implementation of a graphical user interface 502 in accordance with other interfaces discussed herein. The bot development system 108 can provide an authoring view 504 and a property view 506 within the graphical user interface 502. In particular, FIG. 5A shows an example implementation in which a greeting bot asset can be modified or otherwise developed in accordance with one or more embodiments described herein.

In this example, an action box 508a is shown indicating a send response command of the greeting bot asset package indicating a send response command of a bot application responsive to one or more conditions or other triggers. As shown in FIG. 5A, a field of the action box 508a shows a blank message indicating that the bot application may provide no message in response to an associated condition. This may be result of a user deleting previous instructions or simply adding the action box to the greeting bot asset within the authoring view 504 (e.g., similar to one or more embodiments described above in connection with FIGS. 4A-4C).

As shown in FIG. 5A, in response to a selection of the action box 508a, the bot development system 108 can provide a send response interface within the property view 506 of the graphical user interface 502. In this example, the property view 506 may show a single property field 510a including a field within which a user may compose a response for the bot application to provide responsive to an associated trigger or other condition.

It will be noted that FIG. 5A illustrates a simple example and additional property values may be displayed within the property view 506 that enable a user to modify other properties of an associated action and/or asset package. Indeed, as shown in FIG. 5A, the property view 506 may include a plus icon (indicated as “+”) that may provide additional properties that may be added and/or modified to the action associated with the selected action box 508a.

As noted above, a user may compose a response for the bot application within the property icon 510a. For example, as shown in FIG. 5B, a user may type a response “Welcome to the AI help menu. How can I help you?” In one or more embodiments, the bot development system 108 causes the text added to the property field 510a to be translated to the corresponding action box 508b within the authoring view. As shown in FIG. 5B, for example, the code including instructions displayed within the action box 508b may be transcribed to match the content added to the text property box 510b. As further shown, the resulting code may be integrated within framework of a schema or coded instructions having a format that is compatible with incorporating features and functionality of the asset package within the bot application. For instance, in one or more embodiments, the code including instructions displayed within the action box 508b may be transcribed to match any content added to the text property box 510b. Similarly, where changes or content is added directly to a field of the action box 508b, corresponding changes may be translated to the corresponding property field 510b within the property view 506.

The bot development system 108 can translate content added to one or more of the authoring view or property view in a number of ways. For example, in one or more embodiments, the bot development system 108 may maintain a template for the asset package including metadata and other content that corresponds to the content provided via the fields of the authoring view 504 and property view 506. Accordingly, where a change is made to a field within the authoring view 504 or the property view 506, the change may be applied to a field within an asset template, which causes the change to be applied to both the authoring view 504 and the property view 506. Thus, in one or more embodiments, the fields presented within the authoring view 504 and property view 506 correspond to fields within an asset template.

It will be understood that many developers may modify an asset package by adding content to the property view 506 and allowing the bot development system 108 to translate the content within the instructions shown within the authoring view 504. Nevertheless, for more skilled developers or various developers having a certain amount of experience in a particular schema or format, the authoring view can provide a medium for making changes to the asset package and creating components of the asset package themselves. Accordingly, while one or more embodiments described herein provide various tools for simplifying development by selecting and adding pre-packaged assets within an asset framework, a user may nonetheless create components from scratch using more traditional coding techniques by modifying properties displayed directly within the authoring view. Moreover, while this type of development may involve some coding, it is nonetheless more simple and user-friendly than conventional development techniques that involve modifying code of a bot package directly as modifications made within the authoring view are limited to modifications to the specific action or asset package.

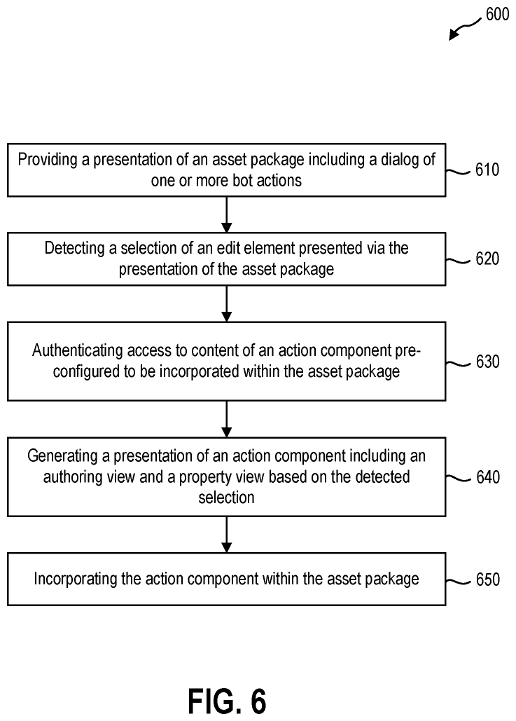

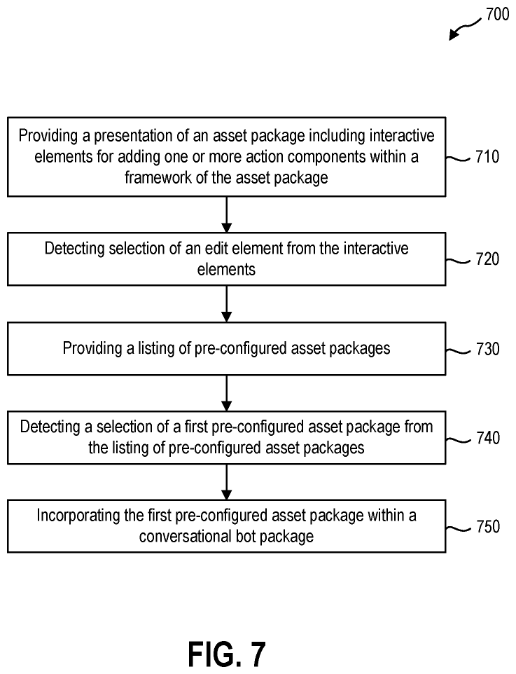

Turning now to FIGS. 6-7, these figures illustrate example flowcharts including series of acts for creating and/or modifying asset packages to be incorporated within a framework of a bot package. While FIGS. 6-7 illustrates acts according to one or more embodiments, alternative embodiments may omit, add to, reorder, and/or modify any of the acts shown in FIGS. 6-7. The acts of FIGS. 6-7 can be performed as part of a method. Alternatively, a non-transitory computer-readable medium can include instructions that, when executed by one or more processors, cause a computing device (e.g., a server device and/or client device) to perform the acts of FIGS. 6-7. In still further embodiments, a system can perform the acts of FIGS. 6-7.

For example, FIG. 6 illustrates a series of acts 600 related to creating and/or modifying asset packages to be incorporated within a framework of a bot package. As shown in FIG. 6, the series of acts 600 includes an act 610 of providing a presentation of an asset package including a dialog of one or more bot actions. In one or more embodiments, the act 610 involves providing, via a graphical user interface of a computing device, a presentation of an asset package, the asset package including a dialog of one or more bot actions being consumable within a bot package. In one or more embodiments, the dialog of one or more bot actions includes at least one pre-configured bot action previously incorporated into runtime functionality of the bot package.

As further shown, the series of acts 600 includes an act 620 of detecting a selection of an edit element presented via the presentation of the asset package. In one or more embodiments, the act 620 involves detecting a selection of an edit element presented via the graphical user interface within the presentation of the asset package.

As further shown, the series of acts 600 includes an act 630 of authenticating access to content of an action component pre-configured to be incorporated within the asset package. For example, in one or more embodiments, the act 630 involves determining that the computing device is authorized to access content of an action component that is configured to be incorporated within a framework of the asset package.

As further shown, the series of acts 640 includes generating a presentation of an action component including an authoring view and a property view based on the detected selection. For example, in one or more embodiments, the act 640 involves generating, based on the selection of the edit element and based on determining that the computing device is authorized to access content of the action component, a presentation of an action component including an authoring view showing an action icon within a framework of the asset package and a property view showing one or more properties of the action component.

As further shown, the series of acts 600 includes an act 650 of incorporating the action component within the asset package. For example, in one or more embodiments, the act 650 may involve incorporating the action component within the framework of the asset package. In one or more embodiments, the series of acts 600 further includes incorporating the asset package within the bot package, the bot package including a plurality of previously incorporated asset packages.

In one or more embodiments, the asset package includes a pre-configured asset package previously authenticated by the computing device and incorporated within the framework of the bot package. In one or more embodiments, the series of acts 600 further includes re-incorporating a modified version of the asset package based on one or more modifications made to the action package within one of the authorizing view or the property view of the presented action package.

In one or more embodiments, the edit element includes an add icon that prompts addition of a new action component to the asset package based on a location of the add icon presented within the presentation of the asset package. The series of acts 600 may include, in response to detecting the selection of the add icon, providing a listing of indicators corresponding to pre-configured action packages configured to be incorporated within the framework of the asset package. In one or more embodiments, the pre-configured action packages include a first one or more asset packages having content that is publicly available and a second one or more asset packages having encrypted content that is selectively accessible to computing devices that are authorized to access encrypted content from the second one or more asset packages.

In one or more embodiments, the pre-configured action packages from the listing of indicators includes at least one local action package stored on a local storage of the computing device and/or at least one third-party action package retrievable from a collection of remotely maintained asset packages. In one or more embodiments, the pre-configured action packages further includes at least one icon corresponding to an adaptive card, the adaptive card including an interactive program configured to be displayed via an application interface associated with an application running the bot package.

In one or more embodiments, the edit element includes a selectable icon representative of one or more action components already included within the framework of the asset package. In one or more embodiments, the series of acts 600 includes detecting a modification to information displayed within the authoring view of the presented action package and causing the modification to be applied to corresponding information displayed within the property view of the presented action package. In one or more embodiments, the series of acts 600 includes detecting a modification to information displayed within the property view of the presented action package and causing the modification to be applied to corresponding information displayed within the authoring view of the presented action package.

FIG. 7 illustrates an example series of acts 700 relates to creating and/or modifying asset packages to be incorporated within a framework of a bot package. As shown in FIG. 7, the series of acts 700 may include an act 710 of providing a presentation of an asset package including interactive elements for adding one or more action components within a framework of the asset package. For example, in one or more implementations, the act 710 includes providing, via a graphical user interface of a computing device, a presentation of an asset package, the presentation of the asset package including interactive elements for adding one or more action components that are consumable within a framework of a conversational bot package.

As further shown, the series of acts 700 may include an act 720 of detecting selection of an edit element from the interactive elements. For example, in one or more implementations, the act 720 may involve detecting selection of an edit element from the interactive elements presented via the graphical user interface.

As further shown, the series of acts 700 may include an act 730 of providing a listing of pre-configured asset packages. For example, in one or more embodiments, the act 730 involves providing, in response to detecting the selection of the edit element, a listing of pre-configured asset packages that are known to be compatible within the framework of the bot package.

As further shown, the series of acts 700 includes an act 740 of detecting a selection of a first pre-configured asset package from the listing of pre-configured asset packages. For example, in one or more embodiments, the act 740 involves detecting a selection of a first pre-configured asset package from the listing of pre-configured asset packages, the first pre-configured asset package having encrypted content that is selectively accessible to one or more computing devices that are authorized to access the encrypted content.

As further shown, the series of acts 700 includes an act 750 of incorporating the first pre-configured asset package within a conversational bot package. For example, the act 750 may involve incorporating the first pre-configured asset package within a framework of the conversational bot package.

In one or more embodiments, the series of acts 700 may include determining that the computing device is authorized to access content of the first pre-configured access package. Further, in one or more embodiments, the series of acts 700 may include generating, based on determining that the computing device is authorized to access content of the pre-configured asset package, a presentation of an action component of the first pre-configured action package, the presentation of the action component including an authoring view showing an action icon within a framework of the first pre-configured action package and a property view showing properties of the action component. One or more features of the action component may be added to the first pre-configured asset package based on edits made to the authoring view or the property view.

In one or more embodiments, the edit element includes an add icon presented via the presentation of the asset package. In one or more implementations, the series of acts 700 includes, in response to detecting the selection of the edit element, providing a listing of pre-configured asset packages that are known to be compatible within the framework of the bot package. In one or more embodiments, generating the presentation of the action component includes providing the authoring view showing the action icon corresponding to a selected asset package from the listing of pre-configured asset packages and providing the property view showing one or more properties of the selected asset package. In one or more embodiments, the pre-configured asset packages include at least one local action package stored on a local storage of the computing device and at least one third-party action package retrievable from a collection of remotely maintained asset packages.

In one or more embodiments, the series of acts 700 includes detecting a modification to information displayed within the authoring view of the presented action package. The series of acts 700 may also include causing the modification to be applied to corresponding information displayed within the property view of the presented action package. In one or more embodiments, the series of acts 700 may include detecting a modification to information displayed within the property view of the presented action package and causing the modification to be applied to corresponding information displayed within the authoring view of the presented action package.

FIG. 8 illustrates certain components that may be included within a computer system 800. One or more computer systems 800 may be used to implement the various devices, components, and systems described herein.

The computer system 800 includes a processor 801. The processor 801 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for managing an asset for incorporation within a bot application, comprising:
providing, via a graphical user interface of a computing device, a presentation of an asset package, the asset package including a dialog of one or more bot actions being consumable within a bot package;
detecting a selection of an edit element presented via the graphical user interface within the presentation of the asset package;
determining that the computing device is authorized to access content of an action component that is configured to be incorporated within a framework of the asset package;
generating, based on the selection of the edit element and based on determining that the computing device is authorized to access content of the action component, a presentation of the action component including an authoring view showing an action icon within a framework of the asset package and a property view showing one or more properties of the action component; and
incorporating the action component within the framework of the asset package.

2. The method of claim 1, further comprising incorporating the asset package within the bot package, the bot package including a plurality of previously incorporated asset packages.

3. The method of claim 1, wherein the dialog of one or more bot actions includes at least one pre-configured bot action previously incorporated into runtime functionality of the bot package.

4. The method of claim 1, wherein the asset package includes a pre-configured asset package previously authenticated by the computing device and incorporated within the framework of the bot package, and wherein the method further comprising re-incorporating a modified version of the asset package based on one or more modifications made to the action package within one of the authorizing view or the property view of the presented action package.

5. The method of claim 1, wherein the edit element includes an add icon that prompts addition of a new action component to the asset package based on a location of the add icon presented within the presentation of the asset package.

6. The method of claim 5, further comprising, in response to detecting the selection of the add icon, providing a listing of indicators corresponding to pre-configured action packages configured to be incorporated within the framework of the asset package. The method of claim 6, wherein the pre-configured action packages include:
a first one or more asset packages having content that is publicly available; and
a second one or more asset packages having encrypted content that is selectively accessible to computing devices that are authorized to access encrypted content from the second one or more asset packages.

8. The method of claim 6, wherein the pre-configured action packages from the listing of indicators includes:
at least one local action package stored on a local storage of the computing device; and
at least one third-party action package retrievable from a collection of remotely maintained asset packages.

9. The method of claim 8, wherein the pre-configured action packages further includes at least one icon corresponding to an adaptive card, the adaptive card including an interactive program configured to be displayed via an application interface associated with an application running the bot package.

10. The method of claim 1, wherein the edit element includes a selectable icon representative of one or more action components already included within the framework of the asset package.

11. The method of claim 1, further comprising:
detecting a modification to information displayed within the authoring view of the presented action package; and
causing the modification to be applied to corresponding information displayed within the property view of the presented action package.

12. The method of claim 1, further comprising:
detecting a modification to information displayed within the property view of the presented action package; and
causing the modification to be applied to corresponding information displayed within the authoring view of the presented action package.

13. A method for managing a conversational asset for incorporation within a conversational bot, comprising:
providing, via a graphical user interface of a computing device, a presentation of an asset package, the presentation of the asset package including interactive elements for adding one or more action components that are consumable within a framework of a conversational bot package;
detecting selection of an edit element from the interactive elements presented via the graphical user interface;
providing, in response to detecting the selection of the edit element, a listing of pre-configured asset packages that are known to be compatible within the framework of the bot package;
detecting a selection of a first pre-configured asset package from the listing of pre-configured asset packages, the first pre-configured asset package having encrypted content that is selectively accessible to one or more computing devices that are authorized to access the encrypted content; and
incorporating the first pre-configured asset package within a framework of the conversational bot package.

14. The method of claim 13, further comprising:
determining that the computing device is authorized to access content associated with the first pre-configured access package; and
generating, based on determining that the computing device is authorized to access content associated with the pre-configured asset package, a presentation of an action component of the first pre-configured action package, the presentation of the action component including an authoring view showing an action icon within a framework of the first pre-configured action package and a property view showing properties of the action component, wherein one or more features of the action component are added to the first pre-configured asset package based on edits made to the authoring view or the property view.

15. The method of claim 14, wherein the pre-configured asset packages include:
at least one local action package stored on a local storage of the computing device; and
at least one third-party action package retrievable from a collection of remotely maintained asset packages.

16. The method of claim 14, further comprising:
detecting a modification to information displayed within the authoring view of the presented action package; and
causing the modification to be applied to corresponding information displayed within the property view of the presented action package.

17. The method of claim 14, further comprising:
detecting a modification to information displayed within the property view of the presented action package; and
causing the modification to be applied to corresponding information displayed within the authoring view of the presented action package.

18. The method of claim 13, wherein the listing of pre-configured action packages include:
a first one or more pre-configured asset packages having content that is publicly available; and
a second one or more pre-configured asset packages having encrypted content that is selectively accessible to computing devices that are authorized to access the second one or more asset packages.

19. A system, comprising:
one or more processors;
memory in electronic communication with the one or more processors;
instructions stored in the memory, the instructions being executable by the one or more processors to:
provide, via a graphical user interface of a computing device, a presentation of an asset package, the asset package including a dialog of one or more bot actions being consumable within a bot package;
detecting a selection of an edit element presented via the graphical user interface within the presentation of the asset package;
determining that the computing device is authorized to access content of an action component that is configured to be incorporated within a framework of the asset package;
generating, based on the selection of the edit element and based on determining that the computing device is authorized to access content of the action component, a presentation of the action component including an authoring view showing an action icon within a framework of the asset package and a property view showing one or more properties of the action component; and
incorporating the action component within the framework of the asset package.

20. The system of claim 19, wherein the pre-configured action packages include:
a first one or more asset packages having content that is publicly available; and
a second one or more asset packages having encrypted content that is selectively accessible to computing devices that are authorized to access the second one or more asset packages.
